(19) United States
(12) Patent Application Publication
(10) Pub. No.: US 2026/0243593 A1
(43) Pub. Date: Aug. 20, 2026

(54) MATERIAL LEVEL SENSOR FOR 3D PRINTING

(71) Applicant: 3D Sil Ltd., Rosh Haayin (IL)

(72) Inventors: Roi Ramot, Rosh Haayin (IL); Yair Ramot, Maas (IL)

(73) Assignee: 3D Sil Ltd., Rosh Haayin (IL)

(21) Appl. No.: 19/055,057

(22) Filed: Feb. 17, 2025

(51) Int. Cl. G01F 23/14; B29C 64/386; B33Y 30/00

(52) U.S. Cl. CPC G01F 23/14; B29C 64/386; B33Y 30/00

(57) ABSTRACT

A material level sensor includes a nozzle in fluid communication with an air source and with an air pressure sensor, a motion actuator in operative relation with the nozzle so as to cause relative motion between the nozzle and a level of a deposited material, and a controller in operative communication with the motion actuator and with the air pressure sensor for analyzing a pressure signal generated by the air pressure sensor and positional data received from the motion actuator to determine the level of the deposited material.

### FIELD OF THE INVENTION

The present invention relates generally to three-dimensional printing, and particularly to a material level sensor for use in 3D printing.

### BACKGROUND OF THE INVENTION

Additive manufacturing is generally a process in which a three-dimensional (3D) object is manufactured utilizing a computer model of the objects. Such a process is used in various fields, such as design related fields for purposes of visualization, demonstration and mechanical prototyping, as well as for rapid manufacturing (RM).

In three-dimensional inkjet printing processes, for example, a building material is dispensed from a dispensing head having a set of nozzles to deposit layers on a supporting structure. Depending on the building material, the layers may then be cured or solidified using a suitable device.

Additionally, the printing system may include a leveling device for leveling and/or establishing the height of each layer after deposition and at least partial solidification, prior to the deposition of a subsequent layer.

Some material level sensors have been described in the art. For example, US Patent Application 2016/0236407 describes a Z-level sensor (Z-level being the vertical level height of the deposited material) which includes “crashing” (in their words) the print nozzle into the print bed, detecting the crash jerk or deceleration, and using this sensed vibration to determine the height of the deposited material. It is clear that this method has serious disadvantages because it can cause damage to the deposited layer. Furthermore, the moment of crash is not accurately measurable.

Some materials, such as silicone, are not easily detected by off-the-shelf fluid level detectors, due to their optic or viscous properties, for example.

### SUMMARY

The present invention seeks to provide a material level sensor, which has many applications, such as for use in 3D printing, as described in detail below. The material level sensor is applicable to flowable materials, such as silicone. With the material level sensor of the invention, accurate silicone medical implants may be printed with ease.

There is provided in accordance with a non-limiting embodiment of the invention a material level sensor including a nozzle in fluid communication with an air source and with an air pressure sensor, a motion actuator in operative relation with the nozzle so as to cause relative motion between the nozzle and a level of a deposited material, and a controller in operative communication with the motion actuator and with the air pressure sensor for analyzing a pressure signal generated by the air pressure sensor and positional data received from the motion actuator to determine the level of the deposited material.

### BRIEF DESCRIPTION OF DRAWINGS

The present invention will be understood and appreciated more fully from the following detailed description, taken in conjunction with the drawings in which:

FIG. 1 is a simplified perspective illustration of a material level sensor, in accordance with a non-limiting embodiment of the invention.

FIG. 2 is a simplified flow chart of using the material level sensor, in accordance with a non-limiting embodiment of the invention.

### DETAILED DESCRIPTION

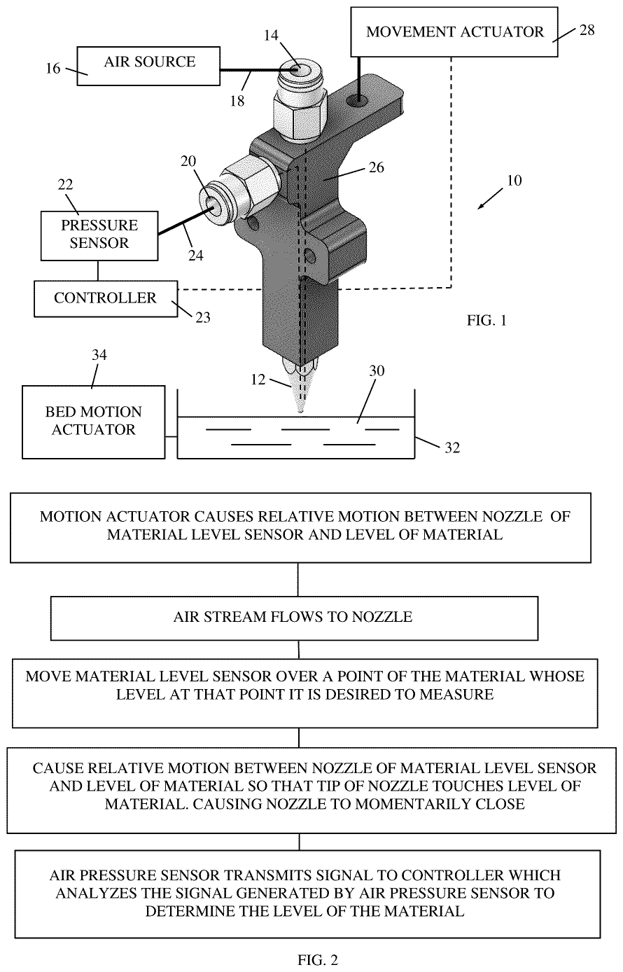

Reference is now made to FIG. 1, which illustrates a material level sensor 10, in accordance with a non-limiting embodiment of the invention.

The material level sensor 10 may include a nozzle 12 which is in fluid communication with an air inlet port 14. The air inlet port 14 is in fluid communication with an air source 16, such as via tubing 18 or other suitable connection.

Nozzle 12 is also in fluid communication with a pressure sensor port 20, which is in fluid communication with an air pressure sensor 22, such as via tubing 24 or other suitable connection. Many kinds of air pressure sensors are readily available on the market.

Nozzle 12 may be coupled to a mounting structure 26. A motion actuator 28, such as but not limited to, a pneumatic or hydraulic or electric piston, servomotor, and others, may be coupled to some portion of mounting structure 26 for moving nozzle 12 at least in the vertical (Z) direction, but preferably in other directions as well. Nozzle 12 is shown in FIG. 1 above the level of a deposited material 30, which has been deposited on a bed 32. Bed 32 may be coupled to a bed motion actuator 34.

Air pressure sensor 22 may be coupled to a controller 23 for analyzing pressure signals generated by air pressure sensor 22 to determine the level of the material (such as the material that has been deposited). Controller 23 also receives positional data from motion actuator 28.

Reference is now made to FIG. 2, which illustrates a simplified flow chart of using the material level sensor 10, in accordance with a non-limiting embodiment of the invention.

First, the motion actuator 28 may lower material level sensor 10 downwards towards the level of the deposited material 30. Alternatively, bed motion actuator 34 may be used to raise bed 34 towards nozzle 12. In general, a motion actuator causes relative motion between nozzle 12 of material level sensor 10 and the level of the deposited material 30, such as but not limited to, silicone, which has been deposited, for example, by a three-dimensional printer.

A weak air stream may flow from air source 16, via connection 18 to air inlet port 14, and then towards nozzle 12.

The motion actuator 28 or bed motion actuator 34 may be used to position the material level sensor 10 over a point of the deposited material whose level at that point it is desired to measure.

The motion actuator (that is, motion actuator 28 or bed motion actuator 34) causes relative motion between nozzle 12 of material level sensor 10 and the level of the deposited material 30 so that the tip of nozzle 12 touches the level of the deposited material 30. This causes nozzle 12 to momentarily close, that is, to have a momentary closure of air flow therethrough. This causes a momentary pressure rise, which is sensed by the air pressure sensor 22. The air pressure sensor 22 may then transmit an electrical signal to controller 23, which analyzes the signals generated by air pressure sensor 22 to determine the level of the material that has been deposited. For example, the controller 23 knows the spatial coordinates of bed 32 and receives spatial positional data from motion actuator 28. The controller 23 knows the spatial position of the tip of nozzle 12 at the moment controller 23 receives the pressure signal indicating when the tip of nozzle 12 has touched the level of the material, and thus can easily calculate the spatial height of the level of the material 30 with respect to the bottom of bed 32.

What is claimed is:

1. A material level sensor comprising:
a nozzle in fluid communication with an air source and with an air pressure sensor;
a motion actuator in operative relation with said nozzle so as to cause relative motion between said nozzle and a level of a deposited material; and
a controller in operative communication with said motion actuator and with said air pressure sensor for analyzing a pressure signal generated by said air pressure sensor and positional data received from said motion actuator to determine the level of the deposited material.

2. The material level sensor according to claim 1, wherein said motion actuator is coupled to mounting structure of said nozzle.

3. The material level sensor according to claim 1, wherein said motion actuator is coupled to a bed of said deposited material.

4. A method of using the material level sensor according to claim 1, comprising:
using said motion actuator to cause relative motion between said nozzle and the level of the deposited material;
causing an air stream to flow from said air source to said nozzle;
positioning the material level sensor over a point of the deposited material whose level at that point it is desired to measure;
using said motion actuator to cause relative motion between said nozzle and the level of the deposited material so that a tip of said nozzle touches the level of the deposited material, causing said nozzle to momentarily close and causing a momentary pressure rise, which is sensed by said air pressure sensor; and
using said controller to analyze the signal generated by said air pressure sensor based on spatial positional data received from said motion actuator to determine the level of the material that has been deposited.
